(19) United States
(12) Patent Application Publication
(10) Pub. No.: US 2022/0111933 A1
(43) Pub. Date: Apr. 14, 2022

(54) SPACE SAVER COOLER MOUNT

(71) Applicants: Austin Chiafos, Cottontown, TN (US); Cassandra Chiafos, Cottontown, TN (US)

(72) Inventors: Austin Chiafos, Cottontown, TN (US); Cassandra Chiafos, Cottontown, TN (US)

(21) Appl. No.: 17/067,669

(22) Filed: Oct. 10, 2020

(51) Int. Cl. B63B 25/00; B63B 25/18

(52) U.S. Cl. CPC B63B 25/004; B60R 9/12; B63B 25/18

(57) ABSTRACT

An article of manufacture for providing a space-saving cooler mount for use on recreational vehicles is disclosed. The cooler mount includes a back support member, having a front side and a back side, coupled to a base support surface along a bottom edge of the back support member. A sliding attachment support is attached to the back of the back support member to retain a sliding support arm. A protruding member coupled to the sliding support arm that extends outward to couple to a second c-clamp used to secure the cooler mount to a vehicle or boat. An attachment tab is located on one side of a first c-clamp that engages the pair of extended members of the pivoting support arm. The first c-clamp also attaches to a vehicle and boat.

### TECHNICAL FIELD

This application relates in general to an article of manufacture for providing physical support structures, and more specifically, to an article of manufacture providing a space-saving cooler mount for use on recreational vehicles.

### BACKGROUND

Usable floor space is typically at a premium when individuals use coolers to store food and drinks while using recreational vehicles including boats, atvs, utvs, tractors and golf carts. Most of the recreational vehicles and boats have multiple support members that allow towers, railings, ladders, and the like to located around the vehicles. These support members are typically of significant size and strength that they may support additional weight if needed. Providing easy access to the coolers while getting them out of the way when not being accessed would improve the user experiences while enjoying the use of recreational vehicles and boats.

Therefore, a need exists for an article of manufacture for providing a space-saving cooler mount for use on recreational vehicles. The present invention attempts to address the limitations and deficiencies of prior art solutions according the principles and example embodiments disclosed herein.

### SUMMARY

In accordance with the present invention, the above and other problems are solved by providing an article of manufacture providing a space-saving cooler mount for use on recreational vehicles according to the principles and example embodiments disclosed herein.

In one embodiment, the present invention is an article of manufacture for providing a space-saving cooler mount for use on recreational vehicles. An article of manufacture for providing a space-saving cooler mount for use on recreational vehicles is disclosed. The cooler mount includes a back support member, having a front side and a back side, coupled to a base support surface along a bottom edge of the back support member. A sliding attachment support is attached to the back of the back support member to retain a sliding support arm. A protruding member coupled to the sliding support arm that extends outward to couple to a second c-clamp used to secure the cooler mount to a vehicle or boat. An attachment tab is located on one side of a first c-clamp that engages the pair of extended members of the pivoting support arm. The first c-clamp also attaches to a vehicle and boat. A pivoting support arm coupled to the back side of the back support, the pivoting support having a pair of extended members out from its base, A sliding attachment support is c-shaped creating a slot that accepts a sliding support arm, the sliding support arm configured to engage a retaining slot in the sliding attachment support, A protruding member coupled to the sliding support arm that extends outward from the back support member when the sliding support arm is within the slot in the sliding attachment support, the protruding member having a through hole passing the protruding member in an orientation parallel to the slot in the sliding attachment support when installed. The second c-clamp having an installation tab extending outward from the second c-clamp and oriented to engage the protruding member using an attachment pin passing through the attachment tab and the protruding member. Removal of the attachment pin detaches the attachment tab and the protruding member to permit the cooler mount to pivot about the first c-clamp as coupled to the pivoting support arm.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates a front view of an example embodiment of an article of manufacture for providing a space-saving cooler mount for use on recreational vehicles according to the present invention.

FIG. 2a illustrates a rear view of an example embodiment of an article of manufacture for providing a space-saving cooler mount for use on recreational vehicles according to the present invention.

FIG. 2b illustrates multiple view of an attachment slide used within of an article of manufacture for providing a space-saving cooler mount for use on recreational vehicles according to the present invention.

FIG. 3 illustrates a top view of the example embodiment of an article of manufacture for providing a space-saving cooler mount for use on recreational vehicles according to the present invention.

FIG. 4 illustrates another top view of the example embodiment of an article of manufacture for providing a space-saving cooler mount for use on recreational vehicles according to the present invention.

FIG. 5 illustrates another rear view of the example embodiment of an article of manufacture for providing a space-saving cooler mount for use on recreational vehicles according to the present invention.

FIG. 6 illustrates components from an example embodiment of an article of manufacture for providing a space-saving cooler mount mounted upon recreational vehicles according to the present invention.

### DETAILED DESCRIPTION

This application relates in general an article of manufacture providing physical support structures, and more specifically, to an article of manufacture providing a space-saving cooler mount for use on recreational vehicles according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “customer,” and “user” refer to an entity, e.g. a human, using a space-saving cooler mount for use on recreational vehicles associated with the invention. The term user herein refers to one or more users.

The term “invention” or “present invention” refers to the invention being applied for via the patent application with the title “Space Saver Cooler Mount.” Invention may be used interchangeably with cooler mount.

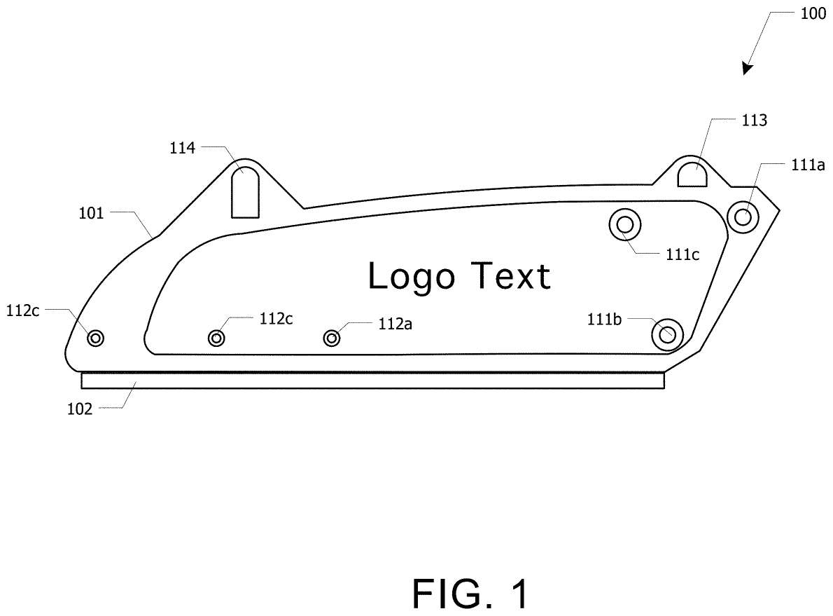

In general, the present disclosure relates to an article of manufacture for providing a physical support structure. To better understand the present invention, FIG. 1 illustrates a front view of an example embodiment for an article of manufacture providing a space-saving cooler mount for use on recreational vehicles according to the present invention. The front view of the cooler mount 100 includes a back member 101 coupled to a base support surface 102 along the bottom edge of the back member 101. The back member 101 has a pair of attachment holes 113-114 along its top edge for attaching straps or cables to hold a cooler in place on the mount while in use. A first set of three attachment devices 112a-c is positioned about a bottom edge of the back member 101 above the connection between the back member 101 and the base support surface 102 closer to a first end of the back member 101. A second set of three attachment devices 111a-c is arranged in a triangular grouping about a second end of the back member 101.

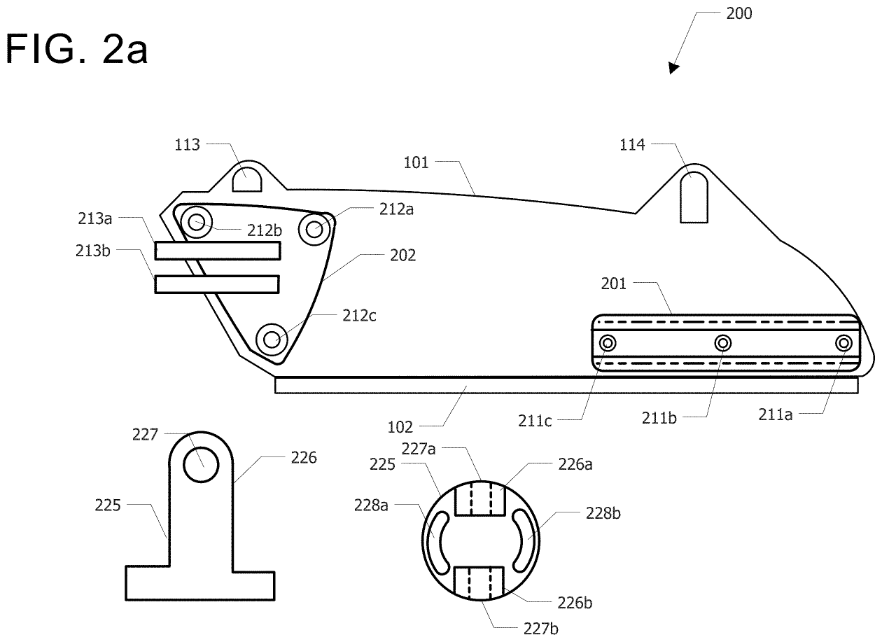

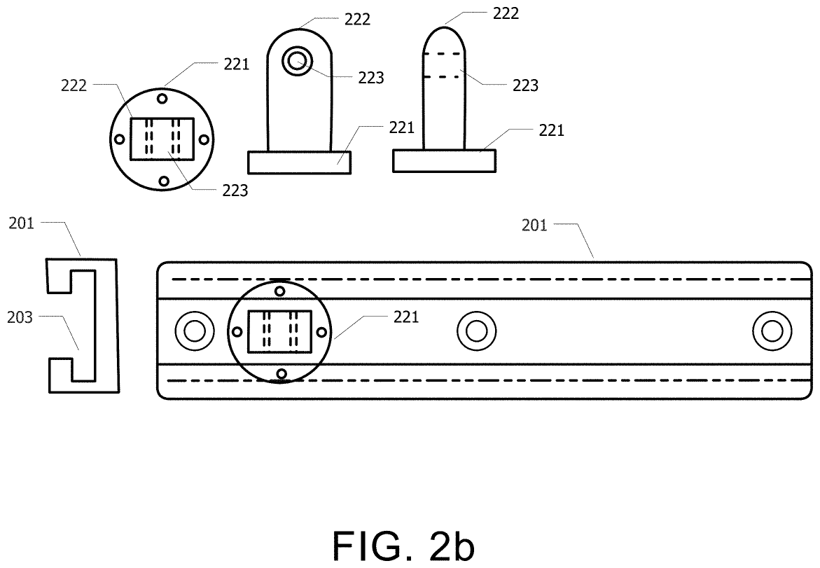

The attachment devices 112a-c, 111a-c may comprise threaded bolts, screws, and the like that either engage bolts or the rear side of the back member 101 or directly engage threaded holes on attachment supports to be coupled to the back member 101. These attachment devices 111a-c, 112a-c pass through the back member 101 through holes located therein. These attachment devices also may include one or more washers, bushings or similar hardware items that assist in coupling the back member 101 to the attachment supports as shown in FIG. 2.

A center portion of the back member 101 may be adorned with a logo or artwork as desired. The logo may reference the source of the box cooler mount 100 or may provide advertising for products related to a cooler or the food and drinks that may be stored therein. The logo may comprise text, graphics or a combination of both.

The back member 101 has a length of 24″ from end to end in a preferred embodiment. The back member 101 is made of aluminum or steel in a preferred embodiment and is 0.5 inch thick and 8 inches high but will vary with cooler size. The support shelf 102 has a length of 19.719″ and is 0.5 inches thick. The support shelf 102 extends 8 inches out from the back member 101 and is 0.5 inches thick to provide a platform to rest a cooler.

FIG. 2a illustrates a rear view of the example embodiment of an article of manufacture providing a space-saving cooler mount for use on recreational vehicles according to the present invention. The rear side of the back support 101 appears as a mirrored image of the front side of FIG. 1 having the pair of attachment holes 113-114 along its top edge. A sliding attachment support 201 is shown along the bottom edge of the back support 101. The sliding attachment support 201 is coupled to the back of the back support 101 by a plurality of attachment devices 211a-c that engage the attachment devices 112a-c on the front side of the back support 101.

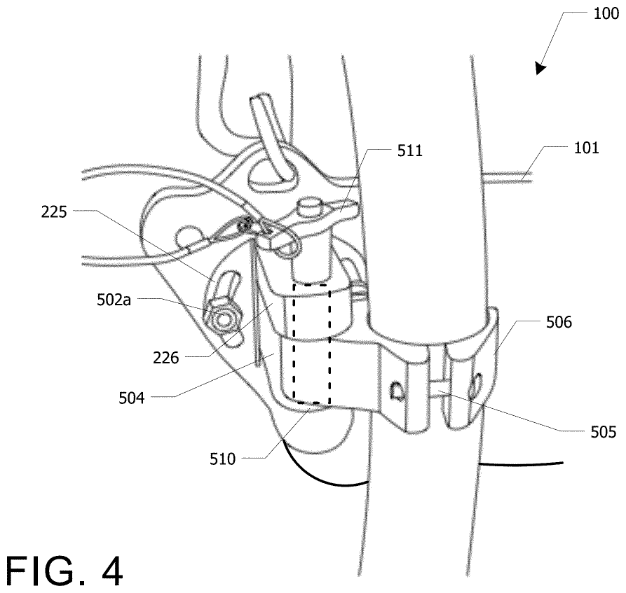

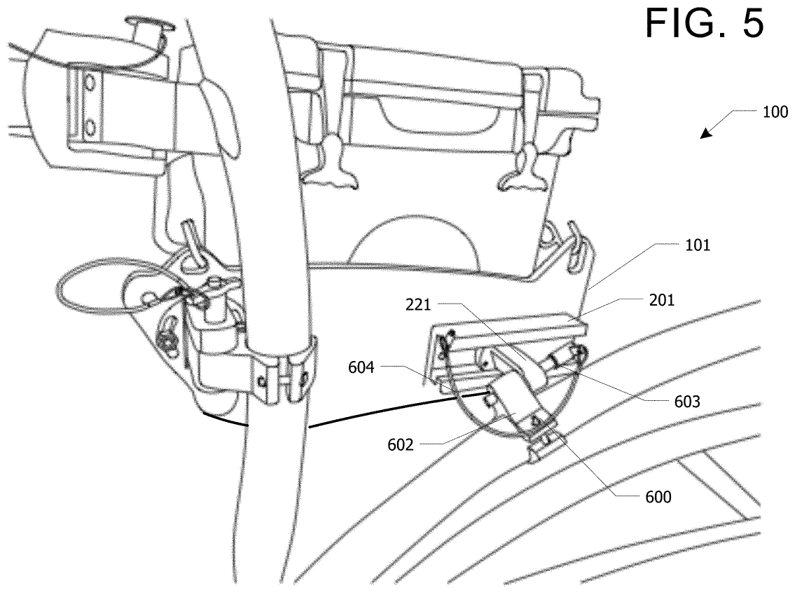

A pivoting support arm 225 also attaches to the back side of the back support 101. The pivoting support arm 225 couples to the back support member 101 using a base support member 202 and attachment devices 212a-c that engage mating attachment devices 111a-c on the front side of the back support 101 as shown in FIG. 1. The pivoting support arm 225 also couples to a mechanism to attach the pivoting support arm 225, and thus the cooler mount 100, to a vehicle or boat. The base support surface 102 is shown attached to the bottom edge of the back support 101. The pivoting support arm 225 has a pair of extended members 226a-b out from its base and has a through holes 227a-b to connect to attachment points on the recreational vehicle as shown in FIGS. 4-5.

The pivoting support arm 225 has a circular base having a diameter of 3.5″ inches. The extended members 226a-b has a height of 3.75″ inches. The pivoting support arm 225 has a pair of opposing attachment slots 228a-b that attach to the back support member 101.

FIG. 2b illustrates multiple view of an attachment slide used within of an article of manufacture for providing a space-saving cooler mount for use on recreational vehicles according to the present invention. The sliding attachment support 201 is shown as a front and side view. The sliding attachment support 201 is c-shaped creating a slot 203 that accepts a sliding support arm 221. The sliding attachment support 201 is 8.870 inches long by 3 inches high. The slot 203 is 2.5 inches tall having a pair of 0.75″ tabs in a front surface to hold the sliding support arm 221 within the slot.

The sliding support arm 221 being coupled to a protruding member 222 is sized and is shaped to engage a retaining slot 204 in the sliding attachment support 201. The sliding support arm 221 may be positioned anywhere along the retaining slot 204 in order to allow the cooler mount 100 to be attached to railings or similar support members when installed on a recreational vehicle or boat. A through hole 223 passes through the protruding member 222 to provide a mechanism to couple the sliding support arm 221, and thus the cooler mount 100, to a vehicle or boat.

The sliding support arm 221 has a circular base having a diameter of 2.5 inches to engage the slot 203 in the sliding attachment support 201. The protruding member 222 has a height of 3.5 inches and a through hole 223.

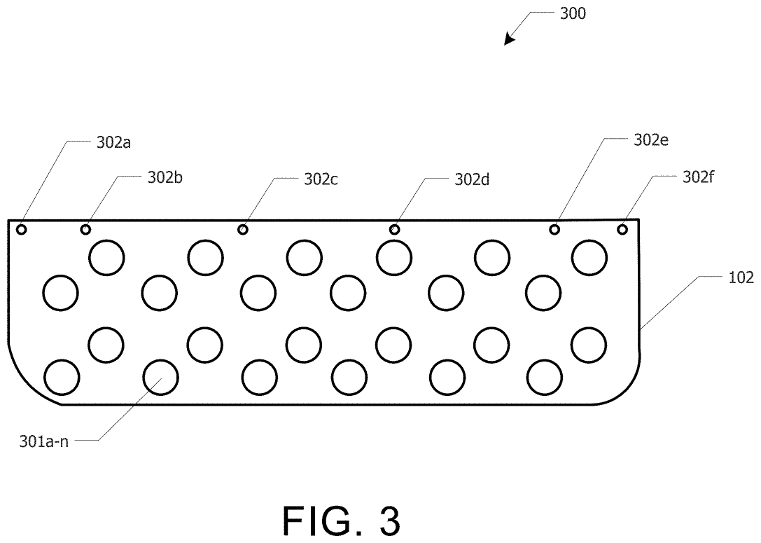

FIG. 3 illustrates a top view of the example embodiment of an article of manufacture for providing a space-saving cooler mount for use on recreational vehicles according to the present invention. FIG. 3 shows a bottom view of the cooler mount 100 and the base support surface 102 is seen as a rectangular surface perpendicular to the back support 101. The base support surface 102 provides a support platform to hold the cooler while in use. The bottom view of the base support surface 102 has a plurality of attachment devices 302a-f to couple the base support surface 102 to the bottom edge of the back support 101. These attachment devices are screws or threaded bolts that pass through the base support surface 102 to engage threaded holes 402a-f in the bottom edge of the back support 101.

FIG. 4 illustrates a rear top view of a pivoting support arm 202 within the article of manufacture for providing a space-saving cooler mount for use on recreational vehicles according to the present invention. In the embodiment of FIG. 4, a triangular-shaped pivoting support arm 501 is shown coupled to the back support 101 of the cooler mount 100 using a nut 502a tightened on a bolt 112a. Two additional bolts, not shown, attach to the other attachment devices 112b-c as discussed above in reference to FIGS. 1-2.

The pivoting support arm 501 comprises a pair of extended support arms 503a-b extending outward in a parallel orientation from the back support 101. The parallel orientation of the pair of extended support arms 503a-b creates an engagement space that accepts insertion of an attachment tab 506 located on one side of a c-clamp 504. The c-clamp 504 may be attached around a railing, support tower or similar location on the recreational vehicle or boat to install the cooler mount 100. The c-clamp 504 is tightened into place using an installation bolt 505 that engages the c-clamp between its open ends. A threaded attachment device such as a bolt or a nut and bolt combination may be used. Tightening of the installation bolt 505 pulls the two open ends of the c-clamp 504 together generating a tight grip around a railing or other installation location.

A threaded shaft 510 has one end coupled to a tightening handle 511 in which the threaded shaft extends downward through the upper extended support arm 503a and the attachment tab 506 located on one side of a c-clamp 504 to engage the lower extended support arm 503b of the two extended support arms 503a-b. The threaded shaft 510 may pass completely through the lower extended support arm 503b to engage a nut, not shown. The threaded shaft also may engage a threaded hole in the lower extended support arm 503b in an alternate embodiment. In both embodiments, turning the tightening handle 511 tightens or loosens the threaded shaft 510.

When tightened, the threaded shaft 510 and the tightening handle 510 pull the pair of extended support arms 503a-b together around the attachment tab 506 of the c-clamp 504 to hold the pivoting support arm in place in a fixed orientation. When loosened, the pair of extended support arms 503a-b separate enough to allow the attachment tab 506 of the c-clamp 504 to pivot around the threaded shaft 510. When the attachment tab 506 of the c-clamp 504 pivots, the entire cooler mount 100 may rotate about the threaded shaft 510.

FIG. 5 illustrates another rear view of the example embodiment of an article of manufacture for providing a space-saving cooler mount for use on recreational vehicles according to the present invention. The sliding attachment support 201 is shown in FIG. 5 having a sliding support arm 221 within the retaining slot 204. An installation pin 603 passes through the through hole 223 that passes through the protruding member 222 as shown above in reference to FIG. 2. The installation pin 603 is attached to a retaining cord 604 that is tied to the sliding attachment support 201, keeping it close for ease of installation.

The installation pin 603 passes through the through hole 223 that passes through the protruding member 222 to engage an installation tab 602 of a second c-clamp 600. The installation pin 603 holds the installation tab 602 to the sliding support arm 221, thus holding the cooler mount 100 to the second c-clamp 600 when the sliding support arm 221 is within the retaining slot 204 of the sliding attachment support 201. The second c-clamp 600 may be installed onto a second railing or tower support in a similar manner described above in reference to FIG. 5.

When the installation pin 603 is pulled out to the through hole 223 that passes through the protruding member 222, the entire side of the cooler mount 100 is detached from the railing of the vehicle or boat. If the installation pin 603 is removed when the tightening handle 511 and threaded shaft 510 are in a loosened position, the sliding attachment support 201 and the corresponding side of the back support 101 may pivot about the threaded shaft 510 as discussed above in reference to FIG. 5. Once the cooler mount 100 is returned to a stowed position, the installation pin 603 may be reinserted to attach the back support 101 to the second c-clamp 600 and thus hold the entire cooler mount 100 in a fixed position. Installation pin has a bearing in it so that it will not fall out while in motion. User must push button at top of pin for bearing to retract and pull out.

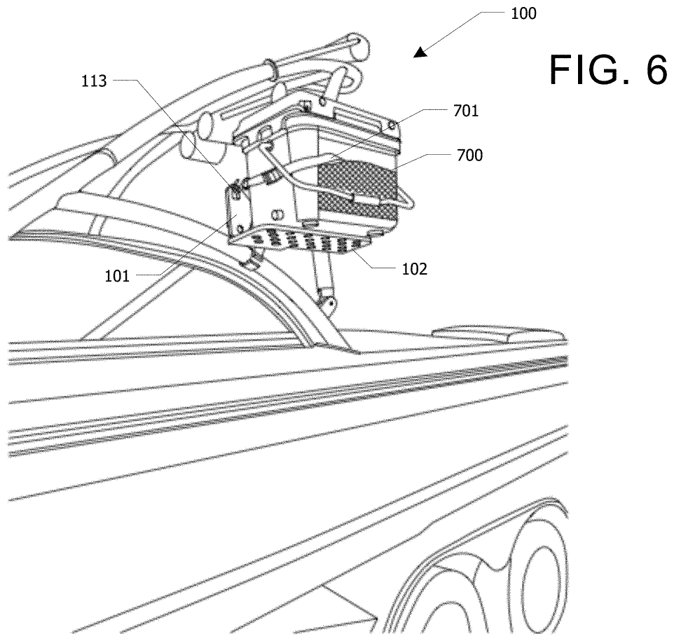

FIG. 6 illustrates components from an example embodiment of an article of manufacture providing a space saving cooler mount mounted upon recreational vehicles according to the present invention. The cooler mount 100 is shown attached to a side of a recreational boat using railings and tower supports otherwise present on the boat. A cooler is placed onto the base support surface 102 and held in place with a restraining strap located around the cooler and attached to the pair of attachment holes 113-114 along the top edge of the back support 101. The cooler mount 100 holds the cooler securely over the outside edge of the boat and consumes none of the limited deck space in the boat used by passengers and crew.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a space-saving cooler mount for use on recreational vehicles, the cooler mount having a back support member 101 and a base support surface, the cooler mount comprises:
the back support member, having a front side and a back side, coupled to the base support surface along a bottom edge of the back support member;
a sliding attachment support coupled to the back of the back support member by a plurality of attachment devices;
an attachment tab located on one side of a first c-clamp that engages the pair of extended members of the pivoting support arm, the first c-clamp attaches to a vehicle and boat;
a pivoting support arm coupled to the back side of the back support, the pivoting support having a pair of extended members out from its base;
a sliding attachment support is c-shaped creating a slot that accepts the sliding support arm, the sliding support arm configured to engage a retaining slot in the sliding attachment support;
a protruding member coupled to the sliding support arm that extends outward from the back support member when the sliding support arm is within the slot in the sliding attachment support, the protruding member having a through hole passing the protruding member in an orientation parallel to the slot in the sliding attachment support when installed; and
a second c-clamp attaches to a vehicle and boat, the second c-clamp having an installation tab extending outward from the second c-clamp and oriented to engage the protruding member using an attachment pin passing through the attachment tab and the protruding member;
wherein removal of the attachment pin detaches the attachment tab and the protruding member to permit the cooler mount to pivot about the first c-clamp as coupled to the pivoting support arm.

2. The cooler mount according to claim 1, wherein the attachment tab of the first c-clamp as coupled to the pivoting support arm with a threaded shaft passing through aligned through holes in the attachment tab and the pair of extending members.

3. The cooler mount according to claim 2, wherein the threaded shaft is secured within the aligned through holes in the attachment tab and the pair of extending members using a threaded nut attached to the end of the threaded shaft.

4. The cooler mount according to claim 3, wherein the threaded nut is coupled to a tightening handle to assist in securing the threaded nut to the threaded shaft.

5. The cooler mount according to claim 1, wherein the attachment pin coupled to the sliding attachment support by a flexible cable keeping it close to the protruding member for installation and removal.
